(19) United States
(12) Patent Application Publication
(10) Pub. No.: US 2002/0132067 A1
(43) Pub. Date: Sep. 19, 2002

(54) Recycling plastic waste

(76) Inventors: William Cartwright, Newport (GB); Robert Cartwright, Newport (GB)

Correspondence Address: Harold L. Novick, NATH & ASSOCIATES PLLC, 6th Floor, 1030 15th Street, NW, Washington, DC, 20005, US

(21) Appl. No.: 10/062,439

(22) Filed: Feb. 5, 2002

Related U.S. Application Data
(63) Continuation of application No. PCT/GB00/03046, filed on Aug. 7, 2000.

(30) Foreign Application Priority Data
Aug. 6, 1999 (GB) 9918454.1

(51) Int. Cl. A01N 3/00; A41G 1/00; B29C 47/00

(52) U.S. Cl. 428/18; 264/41; 264/210.1; 425/376.1

(57) ABSTRACT

A method and apparatus for recycling plastic waste to produce a wood substitute material for use in manufacture of garden products. A mixture of one or more types of plastic materials is extruded in a partially plasticised condition so as to allow gases formed by the extrusion process to escape from the surface of the extrusion to create a simulated wood. Holes (9) formed in the surface of the extruded plastic material by escaping gases are elongated by passage of the extrusion through a finishing die (7) downstream of the extruder (5) to form a rough textured surface similar to sawn wood and the plastic material is set to retain the shape and configuration of the textured surface by cooling in a water bath (8) downstream of the finishing die (7).

This invention relates to the recycling of plastic waste into usable products. More particularly, the invention relates to products made of recycled plastic waste to simulate wood or metal, especially sawn wood or forged metal, having a rough or textured surface. The invention also relates to a method and apparatus for making such products by extruding recycled plastic waste.

Plastic is increasingly being used in place of wood and metal for a wide variety of applications where the resistance of plastic to the conditions in which wood rots and metal corrodes is of particular benefit, for example in the building industry for the construction of doors and windows and in the automotive industry for the manufacture of vehicle components.

Although these properties make plastic an attractive replacement for wood and metal, they are creating a problem for effective disposal of waste plastic produced either during manufacture as scrap or when products reach the end of their service life or are damaged and have to be replaced. In particular, most plastics cannot be safely incinerated due to the production of toxic fumes creating a pollution threat.

As a result, the usual method of disposal of plastic waste is by burying in landfill sites. The use of landfill sites is becoming more uneconomic as a way of disposing of waste materials and has attracted a great deal of adverse publicity. In particular, landfill sites are becoming increasingly difficult to develop as a result of problems experienced through subsidence and the emission of dangerous gases from decomposing waste.

Accordingly, there is a need for effective recycling of plastic waste without recourse to existing methods of disposal by burning or burying. Attempts at recycling plastic waste have not been particularly successful to date. One reason for this is that plastic waste can often be contaminated with other materials which prevent its re-use. Even if separation of plastic waste is possible, this is a time consuming and labour intensive operation so as to be largely uneconomical. As a result, only a small proportion (less than 10%) of currently available plastic waste is in a form suitable for re-cycling.

The present invention has been made from a consideration of the problems of disposing of plastic waste.

It is an object of the present invention to obtain usable products from recycled plastic waste in a simple and cost effective manner.

It is a further object of the present invention to provide a method and apparatus for recycling plastic waste of different types to produce usable products.

It is yet another object of the present invention to recycle plastic waste into usable products by extrusion of the plastic waste without requiring the plastic to be in a substantially pure form.

These objects and the other features, benefits and advantages of the invention will be better understood from the following description.

According to one aspect of the present invention there is provided an article of recycled plastic material having a rough or textured surface formed by escape of gases during extrusion of the plastic material.

The escape of gases during the extrusion process produces an extrusion having a rough or textured surface creating the appearance of sawn wood or forged metal which can be cut to length for producing substitute wood or metal products.

The recycled plastic material may comprise one type of plastic or a mixture of two or more different types of plastic. Where a mixture of different types of plastic is used, this can enhance the simulation of sawn wood or forged metal produced by the rough or textured surface of the extrusion.

According to another aspect of the present invention there is provided a method of forming an article of recycled plastic material having a rough or textured surface by extrusion of the plastic material wherein the rough or textured surface is formed by escape of gases during extrusion.

The escape of gases forms holes in the surface of the extruded plastic material which are preferably elongated in a random manner to form a rough or textured surface similar to sawn wood.

The rough or textured surface may be enhanced by heating the recycled plastic material so as to be partially plasticised whereby variations in the plasticity create drag effects as the plastic material is being extruded. These effects may be further enhanced by using a mixture of recycled plastic materials which plasticise at different temperatures.

The gases are preferably allowed to escape during extrusion by providing an expansion chamber upstream of a former die for extruding a pre-form having any desired cross-section, for example circular, oval, rectangular or the like.

Preferably, the pre-form is subjected to a final shaping operation by providing at least one finishing die for extruding the article with the desired shape. The gases may escape between the former die and the finishing die. The extrusion from the finishing die is cooled to set the plastic material and retain the desired shape of the article, for example by cooling in a water bath.

According to yet another aspect of the present invention there is provided apparatus for forming an article of plastic material having a rough or textured surface by extrusion of the plastic material comprising means for extruding plastic material including a former die having an aperture of pre-determined shape and, upstream of the former die, an expansion chamber for reception of plastic material heated to a condition in which the plastic material can be extruded such that gases present in the heated plastic material escape to produce an extrusion having a rough or textured surface.

Preferably, at least one finishing die is provided downstream of the former die for producing the finished shape of the article. The extrusion from the finishing die is preferably cooled, for example by passing through a water bath, to set the plastic material and retain the shape of the article.

The former die and the finishing die may have apertures of the same shape. Alternatively, the former die aperture may be compatible for use with finishing dies having apertures with a range of different shapes. In this way, the former die does not have to be changed when it is desired to alter the shape of the finished article by using a different finishing die.

According to a further aspect of the present invention there is provided apparatus for extruding plastic material to simulate wood having a rough or textured surface comprising a former die for extruding a pre-form having a first cross-section, a finishing die downstream of the former die for extruding the pre-form to produce a finished article having a second cross-section, and means for elongating holes formed by escape of gases during extrusion of the plastic material to create a textured surface in the finished article to simulate wood.

The first and second cross-sections may be the same or different. The elongation of the holes may be produced by a drag effect during the extrusion process. The drag effect may be controlled by varying the rate of extrusion between the former and finishing dies. For example, a bulge may be formed in the pre-form between the former die and the finishing die.

Extruded articles produced by the invented method and apparatus can be used as a wood substitute in a variety of applications but is especially suitable for producing garden products. For example fencing panels, trellis, feather-edge boards, log rolls, posts, pergolas, gazebos, lattice, checker boards, forest palisades, planter boxes, lawn edging, gravel boards can all be made using wood substitute extruded plastic articles according to the present invention.

The invention will now be described in more detail by way of example only with reference to the accompanying drawings wherein:

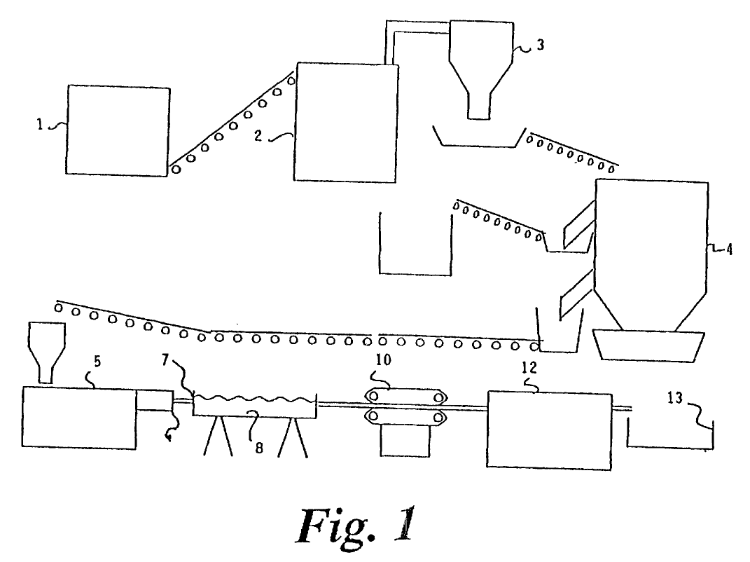

FIG. 1 shows schematically the processing of waste plastic to form it into a product;

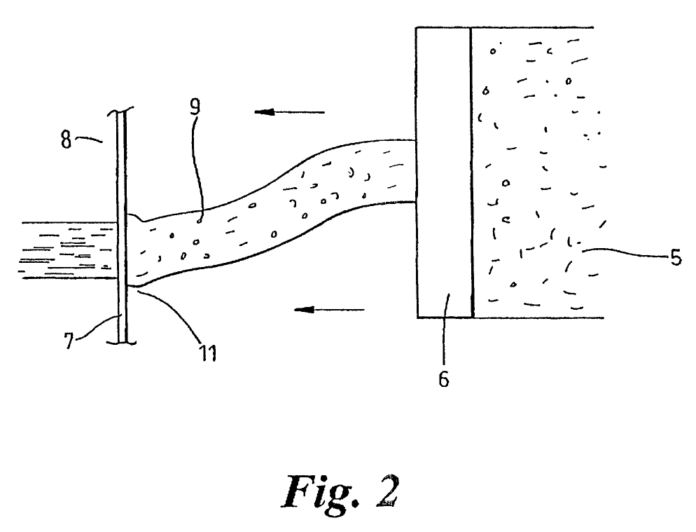

FIG. 2 shows schematically detail of the process of FIG. 1 from an extruder to a cooling bath;

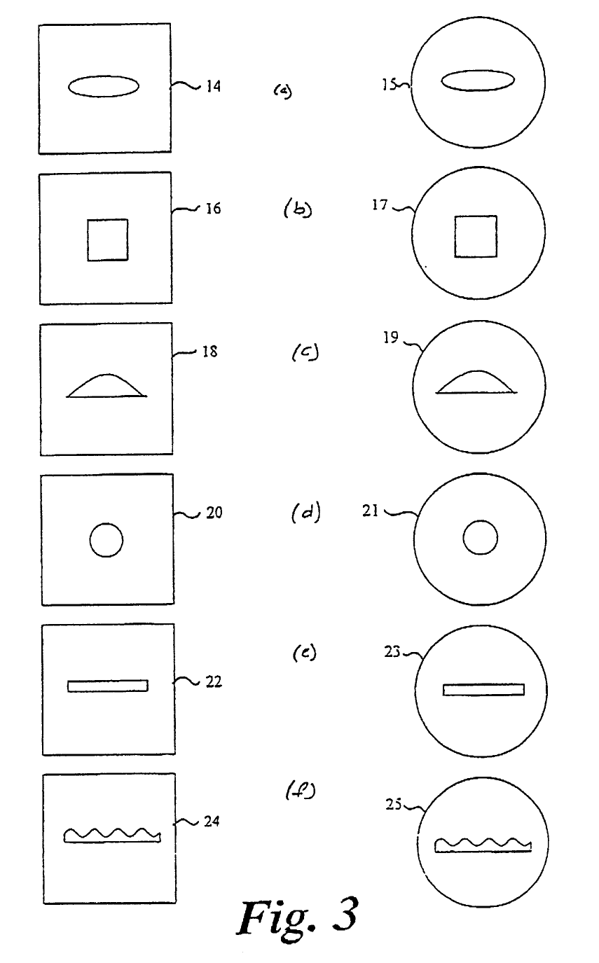

FIG. 3 shows schematically several examples of dies that may be used in the process of FIG. 1; and

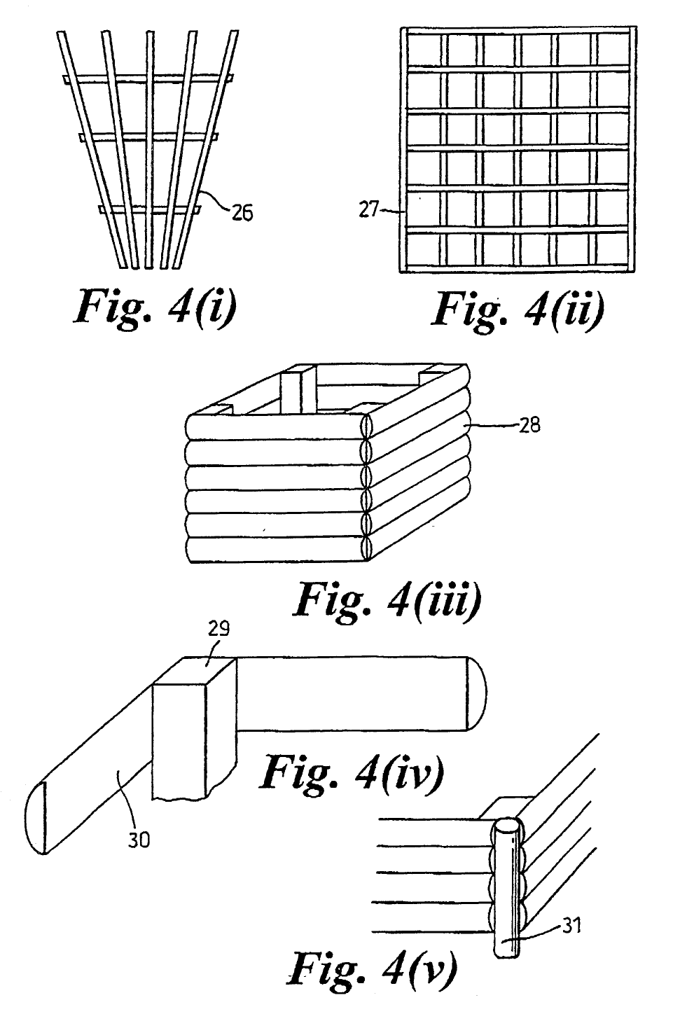

FIG. 4b shows schematically examples of products that may be formed from the process of FIG. 1.

FIG. 1 shows an example of a process suitable for transforming waste plastic into useful products. Waste plastic, stored in bins 1, may comprise only one type of plastic, or several types of plastic from different sources may be contained in one batch. This waste plastic is conveyed from these bins 1 into a granulator 2 where the plastic is granulated. The granulated plastic is then conveyed to a cyclone hopper 3 where it is temporarily stored before being conveyed to a storage/mixer hopper 4. From the storage/mixer hopper the granulated plastic may be put into bags or containers for sale or longer term storage. Alternatively the plastic may be conveyed to an extruder 5. In the extruder 5 the plastic is heated to a temperature just below the plasticity temperature as the plastic may not be required to fully plasticise. The plastic may be heated to or above the plasticity temperature if a smoother surface finish is required.

A head of the extruder 5 is shown in more detail in FIG. 2. Mixing and flow portals have been removed to aid the formation of gasses and texture within the extruder head. A first die 6 is located within the extruder head and forms the basic shape to be extruded. A second die 7 is located at the end of a cooling bath 8 and determines the final shape of the extruded material. The header band temperature at the extruder head containing the first die 6 is normally lower than the preceding header bands within the machine as this increases the drag on the material and contributes to the formation of a textured surface on the extruded plastic.

The aim of the process is to form extruded plastic with a textured surface which resembles a wood grain appearance. The texture is formed from holes 9 which appear in the surface of the plastic between the first die 6 and the second die 7 as the gasses formed by the heating of the plastic in the extruder head escape. As the plastic passes through the second die 7, being pulled through by a haul-off mechanism 10, these holes 9 are elongated due to drag caused by the rough cool surface of the die 7, enhancing the texture.

Many parts of the process contribute to the formation of the textured effect. The use of different types of plastics, each with different plasticity temperatures, creates a grained effect in the final product. The heating of the plastic to just below its plasticity temperature in the extruder 5 prevents the different plastics from mixing completely, and thus the grained effect is maintained. The removal of the mixing and flow portals within the extruder head creates a larger chamber which allows expansion of the plastic and greater quantities of gas to be formed.

The distance between the first die 6 and the second die 7 may be varied to control the amount of gas escaping and thus the graininess of the texture. The speed of the extrusion and haul-off processes is carefully controlled to induce a bulge 11 in the plastic stream just before the second die. This stems the flow of cooling water from the bath and enables the plastic material to be dragged through the second die, creating the desired textured effect.

After passing through the cooling bath 8 and haul off machine 10 the extruded plastic material is cut to length by a saw 12 and stored in racks 13.

A variety of die shapes may be used for the first and second dies. Some of these are shown in FIG. 3. All of the die profile tools are rough cut from mild steel, generally by oxyacetylene. The simplicity of this process allows the creation and manufacture of new dies very quickly from blanks at low cost.

FIG. 3(a) shows an example of die shapes 14, 15 respectively for the first die 6 of the extruder head and the second die 7 of the cooling bath that will produce extruded plastic suitable for struts for a variety of trellis garden products, such as, for example, a fan trellis 26, or a square trellis 27 as shown in FIGS. 4 (i) and (ii)

It is equally possible to produce square section extruded struts 29, for example from square die shapes 16, 17, as shown in FIG. 3(b) for use in the construction of, for example, garden planters 28, shown in FIG. 4(iii), together with half round struts 30 produced from half round die shapes 18, 19, shown in FIG. 3(c). Round section struts 31, shown in FIG. 4(v) produced from round die shapes 20, 21 shown in FIGS. 3(d) can also be used in the construction of garden planters 28, or, for example, as a Log roll. Die shapes 22, 23. 24, 25 suitable for producing slats, for example, are also shown in FIG. 3(f).

The first die 6 may be of a shape compatible with a range of shapes for the second die 7. For example a square shape of the first die may be combined with either a square or a round shape of the second die 16, the extra plastic forming part of the bulge 12. This speeds up changeover.

This process provides an easy and cheap method of recycling plastic material as well as producing useful and aesthetically pleasing products.

1. An article of recycled plastic material having a rough or textured surface formed by escape of gases during extrusion of the plastic material.

2. An article according to claim 1 wherein the recycled plastic material comprises a mixture of two or more different types of plastic.

3. A method of forming an article of recycled plastic material having a rough or textured surface by extrusion of the plastic material wherein the rough or textured surface is formed by escape of gases during extrusion.

4. A method according to claim 3 wherein holes formed in the surface of the extruded plastic material by escaping gases are elongated to form a rough or textured surface similar to sawn wood.

5. A method according to claim 3 or claim 4 wherein the recycled plastic material is heated to a partially plasticised condition during extrusion whereby variations in the plasticity create drag effects as the plastic material is being extruded.

6. A method according to claim 5 wherein the recycled plastic comprises a mixture of plastic materials which plasticise at different temperatures.

7. A method according to any one of claims 3 to 6 wherein the gases are allowed to escape during extrusion by providing an expansion chamber upstream of a former die for extruding a pre-form.

8. A method according to claims 3 to 7 wherein the gases are allowed to escape upstream of a finishing die for extruding the final shape of the article.

9. A method according to claim 8 wherein the article has any desired cross-section, for example circular, oval, rectangular or the like.

10. A method according to claim 8 or claim 9 wherein the extrusion from the finishing die is cooled to set the plastic material and retain the desired shape of the article.

11. A method according to claim 10 wherein the extrusion from the finishing die is water cooled.

12. Apparatus for forming an article of plastic material having a rough or textured surface by extrusion of the plastic material comprising means for extruding plastic material including a former die having an aperture of pre-determined shape and, upstream of the former die, an expansion chamber for reception of plastic material heated to a condition in which the plastic material can be extruded such that gases present in the heated plastic material escape to produce an extrusion having a rough or textured surface.

13. Apparatus according to claim 12 wherein at least one finishing die is provided downstream of the former die for producing the finished shape of the article.

14. Apparatus according to claim 13 wherein means is provided for cooling the extrusion from the finishing die.

15. Apparatus according to claim 14 wherein the cooling means comprises a water bath to set the plastic material and retain the shape of the article.

16. Apparatus according to any one of claims 13 to 15 wherein the former die and the finishing die have apertures of the same shape.

17. Apparatus according to any one of claims 13 to 15 wherein the former die aperture is compatible for use with finishing dies having apertures with a range of different shapes.

18. Apparatus for extruding plastic material to simulate wood having a rough or textured surface comprising a former die for extruding a pre-form having a first cross-section, a finishing die downstream of the former die for extruding the pre-form to produce a finished article having a second cross-section, and means for elongating holes formed by escape of gases during extrusion of the plastic material to create a textured surface in the finished article to simulate wood.

19. An extruded article made by the method or apparatus according to any one of claims 3 to 18.

20. An extruded article according to claim 19 comprising a wood substitute for producing garden products selected from the group comprising fencing panels, trellis, feather-edge boards, log rolls, posts, pergolas, gazebos, lattice, checker boards, forest palisades, planter boxes, lawn edging, and gravel boards.
